(19) United States
(12) Patent Application Publication
(10) Pub. No.: US 2012/0310728 A1
(43) Pub. Date: Dec. 6, 2012

(54) BUY-SIDE ADVERTISING FACTORS OPTIMIZATION

(76) Inventor: Jeremy Kagan, New York, NY (US)

(21) Appl. No.: 13/487,191

(22) Filed: Jun. 2, 2012

Related U.S. Application Data
(60) Provisional application No. 61/492,677, filed on Jun. 2, 2011.

(51) Int. Cl. G06Q 30/02

(52) U.S. Cl. 705/14.43; 705/14.48

(57) ABSTRACT

A computer-implemented system, method, and computer program are disclosed for optimizing buy-side advertising factors for an internet-based first advertising campaign, thereby improving the performance of the first advertising campaign. The optimization involves classifying and identifying stored advertisement campaigns that share similar data, such as subject matter, advertising parameters, and result parameters, to a first advertising campaign that is to be optimized. Advertising factors, including pricing options and pricing values, are then computed by performing multivariate analysis on advertising parameters and result parameters corresponding to the stored advertising campaigns that perform optimally compared to the first advertising campaign to be optimized. The multivariate analysis identifies pricing options, like creative, targeting, and bid cost-per-click (CPC), and related pricing values, where pricing values for each pricing option indicates how an advertiser may spend an existing advertising budget to optimize the first advertising campaign to match the stored and optimally performing advertising campaign.

This application claims the benefit of priority to U.S. Provisional Application No. 61/492,677, filed on Jun. 2, 2011. The contents of this U.S. Provisional Application are hereby incorporated by reference in their entirety.

### TECHNICAL FIELD

The present invention relates generally to internet-based advertising and provides systems, methods, and computer programs for optimizing buy-side advertising factors for interne-I-based advertising campaign.

### BACKGROUND

Online advertisers typically advertise services and products via advertisement software tools. An advertiser uses an advertisement software tool to bid for a cost the advertiser is willing to pay for a click on an advertisement purchased by the advertiser. The advertiser may also include a daily budget for the advertisement, where, when the budget is exhausted, the advertisement software tool does not display the advertisement until more funds are added to the advertising campaign. Accordingly, the advertisement software tool automatically places the advertisements based on the bid value and using the suggested budget distribution. The target audience includes such online criteria as geographical area for the advertisement, websites on which the advertisement may appear, and times of the day at which the advertisement should appear. When the budget for the advertisement is exhausted, the advertisements no longer appear on the selected websites.

Several advertisement software tools provide advertisers with the option to bid for location of an advertisement on a webpage. The advertiser with the highest bid may have its advertisement appearing in a highly visible area, such as, the header of a webpage. A software tracking tool typically tracks the performance of an advertisement, when the advertisement appears on webpages on the internet. Accordingly, the software tracking tool is capable of receiving such information as the number of clicks on an advertisement, the number of times the advertisement appeared, the search words used to make the advertisement appear (on a paid search engine advertisement, for example), and the website on which the advertisement appeared.

Current advertising software allows users to specify a daily budget and a bid value for a cost-per-click that an advertiser is willing to pay for an advertisement to appear on a number of pre-determined websites. The advertiser may adjust a daily budget and the cost per-click based on the current performance of the advertisement in a sell-side method for strategic targeting of advertisements, where the seller of the advertisement space on various websites place advertisements and charge cost-per-click according to the seller's demand and availability of the advertisement spaces.

### SUMMARY

This invention describes exemplary embodiments for computer-implemented systems, methods, and computer programs for optimizing buy-side advertising factors for internet-based advertising campaign by classifying and identifying stored advertisement campaigns that share similar data, such as subject matter, advertising parameters, and result parameters, to a first advertising campaign that is to be optimized. Advertising factors, including pricing options and pricing values, are then computed by performing multivariate analysis on advertising parameters and result parameters corresponding to the stored advertising campaigns that perform optimally compared to the first advertising campaign to be optimized. The multivariate analysis identifies pricing options, like creative, targeting, and bid cost-per-click (CPC), related pricing values, and media property or web site choices where pricing values for each pricing option indicates how an advertiser may spend an existing advertising budget to optimize the first advertising campaign to match the stored and optimally performing advertising campaign

In one exemplary embodiment, a computer-implemented method and system, and computer program product are disclosed. Each of the method, system, and computer program product provides advertising factors, the advertising factors including pricing options and pricing values for internet-based advertising using an advertisement software tool. The advertisement software tool may be resident on a server computer providing services via a website to client computers or may be a stand-alone computer program product including one or more software modules to perform each of the steps described herein. The advertisement software tool receives data related to a first advertising campaign and an existing budget for the first advertising campaign from a potential advertiser, where the existing budget amount is to be distributed among the pricing options to improve the first advertising campaign. The advertisement software tool proceeds to classify the data corresponding to the first advertising campaign. The data includes advertising subject matter, at least one of a number of advertising parameters, and at least one of a number of result parameters.

In an exemplary embodiment, the advertisement software tool classifying the data related to the first advertising campaign performs additional steps for the classification process. Accordingly, the advertisement software tool may associate, on the computer, one or more classification categories to the first advertising campaign, thereby classifying the advertising subject matter of the first advertising campaign. Further, associating classification categories includes adding a software tag to the advertising campaign, where the software tag includes one or more advertising targets for the advertising campaign. The advertisement software tool may then sort, for the first advertising campaign, the corresponding advertising parameters and the corresponding result parameters in accordance to the values stored within each of the corresponding advertising parameters and the corresponding result parameters. The advertisement software tool then provides, to a subsequent identifying step or computer-configured function described below, the classification categories of the first advertising campaign, and a maximum value and a minimum value identified by the storing step or computer-configured function for each of the advertising parameters and the result parameters corresponding to the first advertising campaign.

The advertisement software tool performs an identifying step, to identify one or more stored advertising campaigns with similar classification as the classified data in the classification step. In an exemplary embodiment, the identifying step involves a matching step, on the computer, for matching one or more classification categories of the first advertising campaign with one or more classification categories associated with the one or more stored advertising campaigns, thereby identifying one or more stored advertising campaigns with one or more matched classification categories. The matching may be performed using the software tags disclosed above, where the software tags provide one or an over-lapping classification to the first and stored advertising campaigns, such as, a tag for classifying the advertising campaign as a product, a service, a brand name, by quality, by person name or title, and by product function.

The advertisement software tool may verify if at least one value stored within at least one result parameter corresponding to the matched one or more stored advertising campaigns is optimal compared to a maximum value and a minimum value of a same result parameter corresponding to the first advertising campaign. Optimal values, as disclosed herein, refer to values of result parameters corresponding to a stored advertising campaign that has performed better than or has optimal performance compared to the first advertising campaign received at the advertisement software tool. In an exemplary embodiment, the advertisement software tool may only access the stored advertising campaigns that are identified as optimal by their performance. Accordingly, the corresponding result parameters and advertising parameters form the optimal performance stored advertising campaign, along with their optimal values, are provided to the retrieving step, which is discussed below.

Following identification of one or more stored advertising campaigns, the advertisement software tool performs a retrieving step for retrieving, for each of the identified stored advertising campaigns, a number of corresponding advertising parameters and a plurality of corresponding result parameters. Further, the advertisement software tool then computes advertising factors from at least one of the retrieved advertising parameters and at least one of the retrieved result parameters, the advertising factors including suggested pricing options and pricing values for the existing budget associated with the received first advertising campaign. The computation method involves multivariate analysis on the retrieved advertising parameters and retrieved result parameters to identify from the retrieved result parameters at least one retrieved result parameter that is most affected by the retrieved advertising parameters. Further, the computing step involves a multivariate analysis to identify one of a correlation between the retrieved result parameters and each of the retrieved advertising parameter, a group difference in a group comprising the retrieved advertising parameter values for each retrieved result parameter value, and a dependent and independent relationships between each retrieved result parameter and the plurality of retrieved advertising parameters. Exemplary multivariate analysis used in computing the advertising factor include multiple linear regression analysis, a least square regression analysis, bivariatc analysis, numerical variable transformation, cluster followed by factor analysis, principal components analysis, or a canonical correlation analysis. The existing budget may then be distributed for improving the first advertising campaign in accordance with the computed advertising factors.

### BRIEF DESCRIPTION OF THE DRAWINGS

FIG. 1 is a block diagram depicting a system for optimizing buy-side advertising factors for a first internet-based advertising campaign, according to an exemplary embodiment.

FIG. 2 is a flowchart depicting a computer-implemented method and computer program for optimizing buy-side advertising factors for a first internet-based advertising campaign, according to an exemplary embodiment.

### DETAILED DESCRIPTION

In an exemplary embodiment, the advertisement software tool may be resident on a computer that functions as a backend server. Accordingly, the advertisement software tool utilizes the hardware components of the backend server to perform the software functions for receiving an first advertising campaign, for optimization, by classifying the first advertising campaign, identifying one or more stored advertising campaigns with optimal performance that include similar subject matter, retrieving advertising and result parameters corresponding to the identified stored advertising campaigns, and computing advertising factors. The advertisement software tool functions as an internet-based tool to client computers used by potential advertisers for uploading new or to edit existing advertising campaigns and related advertising campaign budgets. In another exemplary embodiment, the advertisement software tool is a stand-alone computer program product that can be installed from a computer-readable software medium, such as, a compact disc (CD), flash memory drive, or a hard-drive, to a computer directly accessible to the potential advertiser, where the computer program product performs each of the steps disclosed herein independently or by sharing some functions with internet based resources. The computer program product includes an advertising campaign database, and may also access the internet for additional data from an external advertising campaign database.

The advertisement software tool for the stand-alone application or an internet-based application may be accessed via a user-interface deployed as a webpage or an independent software application that may access the internet. A potential advertiser on a computer may direct the computer's web-browser to the internet address of the server hosting the advertisement software tool and provide inputs for a first advertising campaign and related budget to the tool via the user-interface on the browser to initiate the optimization process. The optimization process cumulates with an output of advertising factors, including pricing options and pricing values for allocation of the advertiser's existing budget. The advertiser may spend the advertiser's existing budget in accordance to the advertising factors; thereby improving the performance of the advertiser's advertising campaign.

In certain exemplary embodiments, a potential advertiser may provide first advertising campaign inputs to the advertisement software tool by linking the advertisement software tool to a first advertising campaign that the potential advertiser has deployed in the same or a different online advertisement software tool. By way of an example, the potential advertiser may provide a username, password, and internet-based location of one or more advertisement publishing software tools, such as, Google Adwords® or Yahoo! Advertising®, where each of the advertisement publishing software tools perform the deployment of active advertising campaigns on the internet. A further computation step in the advertisement publishing software tool generates result factors for tracking the performance of the first advertising campaign in accordance with the advertising parameters set for the first advertising campaign. Alternatively, the advertiser manually provides results parameters and advertising parameters corresponding to a first advertising campaign from a different advertisement publishing software tool to the advertisement software tool for analyzing and generating advertising factors. The advertisement software tool uses the received stored parameters from the stored advertising campaign to provide advertising factors for the existing budget available to the first advertising campaign.

In an exemplary embodiment, software tags may provide classification categories that may be used to match stored advertising campaigns to identify optimal performing stored advertising campaigns. Software tags may be assigned to stored advertising campaigns based on the subject matter and keywords assigned to the stored advertising campaign. Further, received first advertising campaigns may be assigned software tags similar to the stored advertising campaigns, or new software tags, when the first advertising campaign includes products or services not covered by the existing stored advertising campaign. Alternatively, the classification categories may be manually entered by the advertiser, where the manual entry process creates a new software tag, related or unrelated to existing stored software tags. By way of examples, “products,” as a classification category include such products as, computers, phones, shoes, clothes, and purses; “services” include physical services, like cleaners and movers, or internet-based services, such as, email service websites and product exchange websites; “brand names” includes such brands as, Gucci®, Microsoft®, and Apple®, where each brand may be used along with a product or service; “product qualities” include categorization based on brands or pricing of products; and “product functions” include products that share at least one similar function, such as, netbooks, tablet computers, and smart phone are related by computing capabilities as their shared product function. “Product,” “brand name,” “product quality,” “product function,” and “service” are used interchangeably as exemplary advertising campaign targets, classification categories, or software tags, as covered in this disclosure.

In an exemplary embodiment, a classification process includes the steps of associating existing or new classification categories in the form of software tags to the first advertising campaign. The association may be performed automatically by a software program for comparing subject matter content of the first advertising campaign with stored advertising campaigns. Alternatively, a manual association may be performed as part of the input process by the potential advertiser. A first advertising campaign that has been active over several time periods, e.g., a week or several days, may include collected data in the form of result parameters for the first advertising campaign. When the advertising parameters and result parameters are provided to the advertisement software tool as part of the first advertising campaign submitted by a potential advertiser, the advertisement software tool sorts the result parameters corresponding to the first advertising campaign. The sorting may be performed by the collected data value within the result parameters.

In an exemplary embodiment, an ascending or a descending sort of the values for each of the result parameters collected during pre-defined time periods will result in a listing of a maximum and a minimum value for one or more of the result parameters. The maximum and minimum values of the result parameters and the advertising parameters used to generate the result parameters are provided as specific inputs for the identifying step, where the identifying step identifies one or more stored advertising campaigns with similar classification as the classified data in the classification step. Accordingly, the identifying step of the advertisement software tool finds one or more stored advertising campaigns with the same subject matter as the first advertising campaign, with each of the one or more stored advertising campaigns having performed optimally in comparison with the first advertising campaign. Further, the advertisement software tool may extract advertising and result parameters corresponding to the identified stored advertising campaign, where the identified stored advertising campaign is an optimally performing active or inactive stored advertising campaign in comparison to the first advertising campaign.

In an exemplary embodiment for determining optimally performing active or inactive stored advertising campaigns, the result parameters for the stored advertising campaigns are evaluated for optimal values. By way of an example, for search-engine advertisement ranking, an optimal value for a ranking-type result parameter may be 1, where the advertising campaign has an average position of being placed as the first advertisement on a webpage. For non-search engine webpages, the ranking of 1 may indicate a favorable location on the webpage, e.g., a page header for the advertisement, compared to the page footer or other locations on the webpage, where each location is assigned a different (usually lower) ranking to differentiate the area of the webpage, its accessibility to advertisement to an end-user or a potential customer on the webpage, the available size of the area, and a pricing. For a range of rankings for the first advertising campaign, e.g., 2 to 4, 2 is its current maximum value and 4 is a current minimum value for the ranking-type result parameter, the optimal value is 1, which may have been attained by one or more stored advertising campaigns with similar subject matter to the first advertising campaign. Further, the system and method disclosed herein generates suggested improvements and priorities the suggest improvements, including price ranges and improvement areas, with reference to the advertiser's submitted advertising campaign.

In another example, for a different result parameter with an optimal value, e.g., conversion rate, a high conversion rate is an optimal value. The conversion rate indicates that end-users or customers are engaged by the advertisement and click on the advertisement, thereby navigating to certain webpages underlying the advertisement. A mathematical representation of the conversion rate is the ratio of the number of end-users on a webpage contacting the webpage owner, visiting the certain webpage underlying the advertisement, or purchasing a product/service from the webpage to the number of actual clicks for the advertisement overlying the webpage. Accordingly, for a received first advertising campaigns of similar subject matter to one or more stored advertising campaigns, if the maximum conversion rate on the first advertising campaign is 0.3%, while the conversion rate for most of the stored advertising campaigns is a mode and/or a median of 0.5%, then 0.5% may indicate optimal value for all advertising campaigns of similar subject matter. As a result, it would be beneficial to apply the same advertising parameter values (by evaluation median/mode values for each of the same advertising parameter values across the stored advertising campaigns) corresponding to the stored advertising campaigns with optimal performance to the first advertising campaign, thereby effectively improving the first advertising campaign from a conversion rate performance value of 0.3% to close to 0.5%.

In an exemplary embodiment, the input fields for the advertisement software tool includes data fields for a first advertising campaign budget field, classification categories, and other advertising parameters that the advertiser currently uses. Further, the information on the classification categories for the first advertising campaign includes initial advertising campaign content, such as subject matter, keywords, and target for the advertising campaign. The target for the advertising campaign includes one or a combination of a product, a service, a brand name, a product quality, a person, and a product function. The target may be defined by software tags that may be existing software tags or newly created software tags, each attached to the first advertising campaign by the advertiser, prior to being stored and activated.

In an exemplary embodiment, an identification module of the advertisement software tool matches the classification categories identified by the software tags of the first advertisement campaign to software tags corresponding to one or more stored advertising campaigns. The matching process for the stored advertising campaigns identifies same or a contextually similar target represented by the subject matter of the first advertising campaign received at the advertisement software tool. The stored advertising campaigns may be active or inactive advertising campaigns and are located in an advertising campaign database accessible to the advertisement software tool. When the advertisement software tool is an internet-based software tool, then the advertising campaign database may be stored on a server optimized for database hosting, data searching, and data retrieving. When the advertisement software tool is installed from a computer-readable medium to a computer for a potential advertiser, then the advertising campaign database may be resident on the computer-readable medium or the installed computer.

Further, in an alternative embodiment, aside from software tags, words and other textual content from a first advertising campaign content may be matched with the stored advertisement campaigns to identify a stored advertising campaign with the same or a similar subject matter. In an exemplary embodiment, the advertisement software tool can also retrieve contextually similar subject matter. By way of an example, for a new “tablet computer” advertisement campaign, a contextually similar stored advertising campaign may be a stored advertising campaign for a “laptop computer.” The table computer and laptop may form narrow classification categories (with software tags) to a broader classification, such as “computers.” Further, computers may form a part of the “electronics” classification, and may overlap with another classification, for example, “brand name,” “product quality,” “price,” or “retailer.”

The advertisement software tool retrieves result parameters and advertising parameters corresponding to the identified stored advertisement campaigns to compute advertising factors, thereby enabling an advertiser to optimize spending of existing advertising campaign budget to improve the first advertising campaign in accordance with the pricing options and pricing values presented in the advertising factors. In an exemplary embodiment, the advertiser may choose to perform a second classification and identification for the first advertising campaign by manually changing the target or the specific result parameter to be optimized of the first advertising campaign. By way of an example, if the advertiser intends to optimize the ranking of the first advertising campaign, as against, improving the conversion rate. Accordingly, the pricing options may provide select pricing options including investment in certain advertising parameters, e.g., daily budget and bid CPC that may be optimized to achieve a higher ranking, or creative, e.g., textual content, colors, fonts, images, and other creative content of the advertising campaign to achieve an attractive advertisement and, subsequently, improved conversion rates.

In an exemplary embodiment, advertising parameters are parameters available for personalization by the advertiser. In the advertisement software tool, exemplary advertising parameters include cost-per-click bid value, budget-per-day, target geographical location, target websites, the creative content, and key-words. Cost-per-click bid value is the monetary value that the advertiser is willing to pay when a random potential customer on a website clicks on an advertisement that is a part of the advertiser's advertisement campaign. Budget-per-day is a monetary budget that is available to the advertisement software tool, where, when the budget is exhausted by several clicks on the advertiser's advertisement, the advertisement no longer appears. Target geographical location is the general geographical area of computers on which the advertisements may appear. Target websites are the websites on which the advertisements may appear. For an advertising campaign including multiple advertisements, each targeting a different product, target, brand, quality or a combination of targets, the advertiser may also provide, for each advertisement, the key-words underlying the creative content, target websites, and other advertising parameters. Further, the advertiser may provide an additional advertising parameter in the form of a budget-per-advertisement within the advertising campaign budget. The tracking software tool analyzes the performance of an internet-based advertising campaign using the underlying key-words for the advertisement campaign. The advertiser may also choose to include certain websites for displaying the internet-based advertisement, thereby targeting specific market segments, e.g., social websites, youth-oriented websites, and other target-specific websites (targeting age, gender, income groups, etc.).

For online internet-based advertising, key-words may be used to direct the advertisement software tool to display an advertisement when the key-word appears on the webpage. By way of an example, an end-user or a potential customer searches for the search term, “cars” in a search engine website; a responsive result webpage in the search engine displays websites related to the search term “cars,” along with a listing of advertisements related to the key-word “cars.” A website hyperlink may be provided for each of the listed advertisements, where, when a potential customer clicks on one of the listed advertisements seeking more details, the potential customer is automatically directed to an advertisement website or an advertisement webpage within an advertisement website including requested details for the target product or service in the advertisement. The advertisement webpage or website may be the destination website for the advertiser, such as the advertiser's product catalog or online sales website.

In an exemplary embodiment, result parameters are parameters that are tracked by a tracking software tool for further analysis and mapping. The result parameters include the number of impressions, the average actual CPC, the average ranking, the conversion rate, click through rate (CTR), and a cost per mille impressions (CPM), each related to a deployed advertisement campaign, over a pre-defined period of time. The average actual CPC provides the actual, real-time CPC charged to advertiser at the time the advertisement was displayed and clicked on, versus a CPC bid, which provides an estimate position based on other bids at the time of bidding. The average ranking is the average ranking of the advertisement when the advertisement was displayed over a pre-defined period in time. An impression refers to an advertisement placed on a webpage for display to a customer. An impression may not be charged to the potential customer by the advertisement software tool. However, a ratio of the number of clicks to the number of impressions may indicate the usefulness of the advertisement's creative content and is a measure of the click through rate. The CPM is a monetary number measured by the cost of the advertisement to the number of impressions of the advertisement, in units of one thousand (cost per thousand views of the advertisement). An effective CPM (eCPM) is the ratio of the monetary value for a number of clicks generated from a number of impressions to the number of impressions, multiplied by 1000. Another result parameter may be a cost-per-action (CPA) parameter, where the advertiser is charged for a customer action. Exemplary customer actions include a completed form, a submitted email, a successful download, etc. This may be implemented via third-party affiliates using an affiliate commission basis to measure costs and results related to CPA.

The software tracking tool may also be used to track if a potential customer on a random website clicks an advertisement and then browses the advertisement website and spends time on a special webpage within the advertisement website, where the special webpage is different from the initial landing advertisement webpage to which the potential customer is automatically directed. This allows the tracking software tool to measure the potential customer interest, since the potential customer browsed to the special webpage for information. By way of an example, a tracking software code from the tracking software tool may be embedded into a “contact us” webpage in the advertisement website, where the “contact us” page is a special webpage providing customers with specific contact information for the advertiser. This tracking software code allows for a software tracking tool to generate a conversion rate, which is the ratio of the number of customers who visit the special webpage in the advertisement website to the number of people who clicked on the advertisement. The special webpage may include webpages with embedded contact forms, to send potential customer information to the advertiser, or purchase webpages, where customers may make a purchase for an advertised target product or service.

In an exemplary embodiment, advertising parameters and related result parameters of stored advertising campaigns are stored in the advertising campaign database for future use. The advertisement software tool may identify stored advertising campaigns that share similar subject matter to the first advertising campaigns and then retrieve corresponding advertising parameters and result parameters, both of which may be used for the received first advertising campaign, as discussed above, to generate similar optimal performance as the result parameters corresponding to the stored results parameter. The advertiser may provide such input for the first advertising campaign, including textual content, images, and other additional advertising parameters that can be used to classify the first advertising campaign. The tracking software tool may have access to the advertisement software tool for tracking deployed first or stored advertising campaigns across multiple websites.

In an example, the advertisement software tool measures contextual similarity of a matching stored advertising campaign by measuring a correlation of a combination of the stored advertising parameters and the stored result parameters using multivariate analysis. Each of the stored advertising parameters and the stored result parameters are used to generate advertising factors for optimizing advertising campaign budgets for the first advertising campaign related to the same subject matter as one or more stored advertisement campaigns.

By way of an example, a stored advertising campaign content that lists a sale, an offer, or is creative by way of its content may attract end-users' interest, thereby resulting in high CTRs and a high conversion rates even for a low ranking or low number of impressions. The creative content of an exemplary advertising parameter corresponding to the stored advertising campaign, while the CTR and conversion rates are the exemplary result parameters corresponding to the same advertising campaign. Accordingly, in some cases, for an advertisement without sufficient creative content, the CTR may be much less for the same number of impressions and the CPM may also be low. The correlation between creative content and CTR and CPM may be measured by a correlation analysis as a part of a multivariate analysis approach to identify advertising parameters that have high effects on the result parameters, both corresponding to an identified stored advertising campaign. The advertisement software tool may use this information to generate advertising factors to the advertiser, where the advertising factors includes a price option with a price value with ranges indicating how the received budget may be allocated for different pricing options of the advertisement campaign, such as, a higher allocation in creative pricing options or in publishing pricing option, by high CPC bids or a different online publishing software tool. Where the different online publishing software tool may be capable of accommodating lower bid CPC or a more accurate target market. As a result, the advertiser may spend, from the existing advertising budget, according to the recommended price options for creative in the first advertising campaign over a different advertising factor, such as a CPC bid.

In one example, analyzing the actual average ranking or placement of a stored advertising campaign that shares similar subject matter to the first advertising campaign can be used to generate advertising factors with allocation information for the CPC part of the first advertising campaign budget. Here, a measure of correlation between certain advertising parameters to result parameters corresponding to one or more stored advertising campaign may provide advertising factors in the form of one pricing option and associated pricing values for a part of the existing budget of the first advertising campaign. By way of an example, a correlation analysis of such advertising parameters as the daily budget and the CPC bid values, against the results parameters, such as, the actual CPC value and the ranking, all corresponding to one or more stored advertising campaigns provides advertising factors that may be used to determine an effective distribution for the existing budget, including an optimal bid CPC of the first advertising campaign. The rankings from the result parameters corresponding to the stored advertising campaign provides an advertiser with an estimate on the budget allocation required to achieve a similar ranking for an existing or new advertisement targeting a same or similar product, when the advertisement content is the same as the stored advertisement campaign. A combination of the advertising factors for CPC allocation and creative allocation may be determined for a given existing budget for the first advertising campaign.

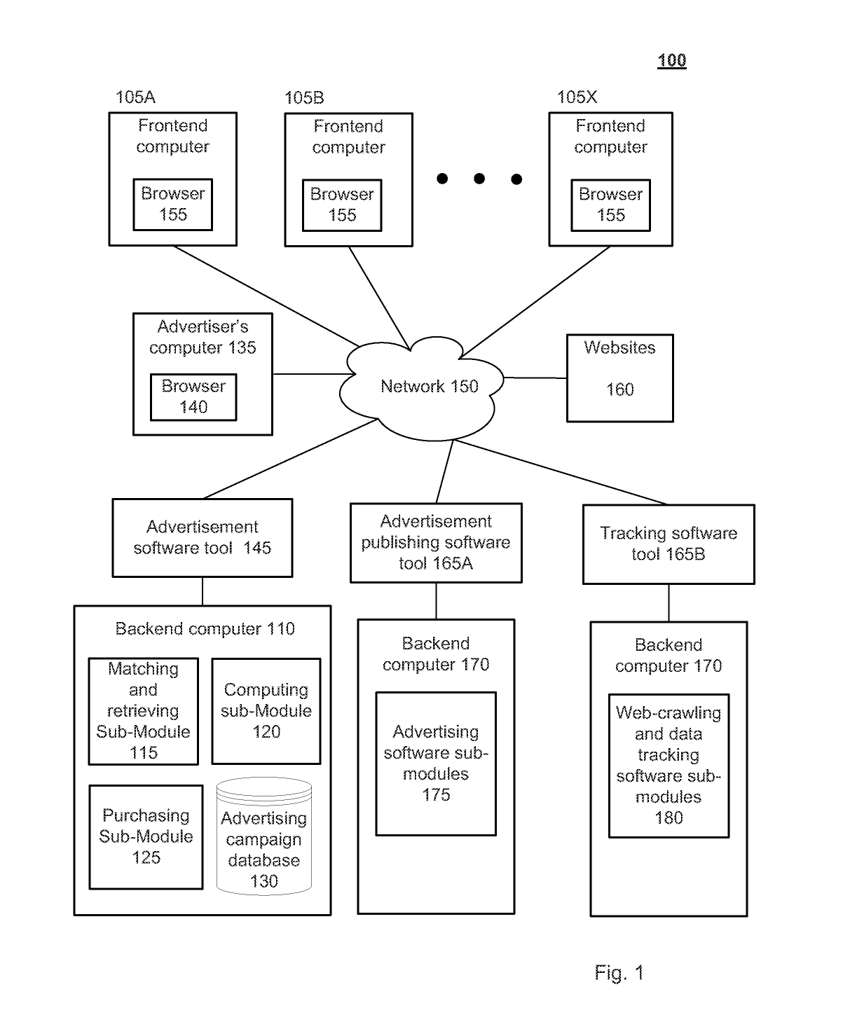

FIG. 1 is a block diagram depicting system 100 for optimizing buy-side advertising factors for intern et-based advertising, according to an exemplary embodiment. Customers or end-users on computers 150A-X access websites 160 via a network 150, such as the internet. A potential customer may access one of a number of websites 160 using a browser 155 software application of the computer 150A-X. When the potential customer accesses a search engine website, a news website, a product website, blogs, or social networking websites, advertisements are displayed based on the contents of the webpages displayed to the user. An advertiser uses computer 135 to access one of a number of software tools 145 and 165A-B for creating, deploying, and monitoring advertisements. It is appreciated that the software tools may be integrated into a single application software tool for optimizing user submitted advertising campaigns and budgets, where one or more advertisements in the advertisement campaigns are published to selected websites and are monitored by the external tracking software tool 165B. Further, the advertiser may access each of the software tools 145 and 165A-B via stand-alone software applications or browsers 140 on the advertiser's computer 135.

Each of the advertisement software tool 145, the advertisement publishing software tool 165A, and the software tracking tool 165B may typically include a user verification process step prior to accessing the advertiser submitted information, the analysis information, or the performance information. The advertisement software tool 145 includes the backend computer 110, which may be a server with multiple software sub-modules 115-125 for performing certain dedicated tasks. The backend computer 110 includes a database 130 for storing existing advertising campaigns, including all related advertising parameters and result parameters for each of the stored advertising campaigns. Backend computers 170 support the advertisement publishing software tool 165A and the tracking software tool 165B. The advertising software sub-module 175 provides the advertising placement for websites 160 after receiving the advertising parameters for a first advertising campaign from an advertiser.

The tracking software tool relies on the web-crawling and data tracking software sub-modules 180 to analyze the performance of advertisements on websites 160. The software sub-module 180 receives tracking information from websites 160, including a hyperlink or uniform resource locator (URL) of websites 160, exit hyperlinks, time spent on a website, keywords used to search for content on a website, and other related information. The hyperlink or uniform resource locator (URL) of websites 160 displays an advertisement submitted by an advertiser or information related to the entry hyperlink used to enter an advertisement website or webpage. The tracking information also determines the number of impressions and the number of clicks. The tracked in formation may be analyzed to provide statistical information related to the advertisement, including the CPC, CPM, and conversion rates, which may be calculated from the budget set by the advertiser and the actual CPC information tracked by the software.

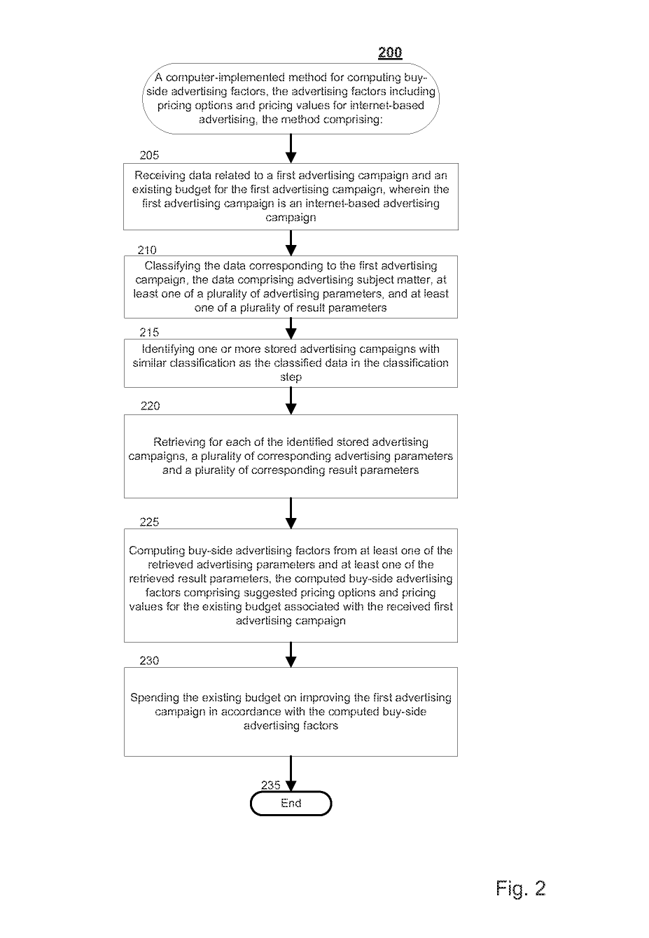

FIG. 2 is a flowchart depicting a computer-implemented method 200 for optimizing buy-side advertising factors, the advertising factors including pricing options and pricing values for internet-based advertising, in accordance with an exemplary embodiment. Method 200 may be implemented as part of the advertisement software tool for optimizing buy-side advertising factors. Block 205 of the advertisement software tool receives data and an existing budget related to a first advertising campaign, the data including an advertisement description with product, brand name, quality, keywords, and other targeting information for an advertising campaign by the advertiser. A classification step is performed by a sub-module of the advertisement software tool via block 210, where the classification sub-module classifies the data received in the first advertising campaign with a number of stored internet-based advertising campaigns. The classification step entitles matching the stored advertising campaigns by their software tags or their textual content with the first advertising campaign. The stored advertising campaigns may be currently active or de-activated advertising campaigns. The first advertising campaign may be an active advertising campaign that the advertiser submits for improvement.

The received first advertising campaign is classified by comparing words and textual content of the first advertising campaign and the other data submitted by the advertiser with stored advertising campaigns in the advertising campaign database. One or more stored advertising campaigns may be identified where the stored advertising campaign shares similar subject matter to the first advertising campaign. Further, the identified stored advertising campaign may be chosen only when the stored advertising campaign is an optimally performing advertising campaign for the same subject matter. When a stored advertising campaign is identified via block 215, the stored advertising campaign typically includes a related set of stored advertising parameters and stored result parameters. The stored advertising parameters and stored result parameters are retrieved via block 220. The retrieved advertising parameter and the retrieved result parameter include values associated to each of the parameters. In certain exemplary embodiments, where more than one stored advertising campaign exists for the same subject matter as the first advertising campaign, then a mode and median values for advertising parameters and result parameters for the optimally performing stored advertising campaigns are retrieved.

Block 225 performs a computing step using multivariate analysis to generate advertising factors for each of the retrieved result parameter values. The advertising factors provide a numeric measure to the significance of each retrieved advertising parameter to the retrieved result parameters via pricing options and pricing values. By way of an example, if among bid CPC values, conversion rates, and budget-per-day values, as obtained from the retrieved advertising parameter, the bid CPC values have low correlation to the average placement ranking of the retrieved advertisement campaign, then the advertising factors will indicate that the bid CPC is not a material contributor to the retrieved advertising campaign. In other words, for a similar first advertising campaign to the stored advertising campaign, the first advertising campaign to be deployed in real-time on the internet, the existing advertising campaign budget for the first advertising campaign need not focus on making high CPC bids. In an example, the multivariate analysis uses pattern matching methods to identifying similar groupings or patterns of performance of the result parameters for a set of advertising parameters submitted by an advertiser.

In an exemplary embodiment, the pricing options may provide the advertiser with options to invest the existing budget in improving the creative implementation of the first advertising campaign or changing the websites that display the advertisement to a different media channel, target market, or technology base. By way of an example, different media channels include websites with different target orientation, such as, an intent-oriented website, an information-oriented website, or an interaction-oriented website. Search engines are examples of an intent-oriented website, where the website provides information requested by the end-user and the corresponding advertisements on such websites are related to the end-user's requests. News websites are examples of the information-oriented website, where the news websites provide information to the end-user irrespective of the end-users with requiring a request for specific information type. Accordingly, in most news websites, the advertisements are tied to the information on the website and not necessarily to the end-user's requests. Interaction-oriented websites provide end-users with interaction capabilities with each other and also with advertising campaigns. Social media sites such as Facebook® are examples of interaction-oriented websites. These sites provide for interaction with other users or members of the site as a primary utility. Technology based targeting focuses on the advertising platform offered by certain websites. In one example, audio, video, or game interactivity may be offered by certain websites, where the advertisement is an interactive advertisement. In this case, the suggested CPM may be higher than the regular CPM for a non-interactive advertisement. The suggested pricing options may include the base suggested CPM with additional costs related to interactive technology based websites.

The pricing options may provide options to invest the existing advertising budget in one of these creative placement options. In another example, the selection of the website type may rely on the ranking and bid CPC required to rank high on the selected website. These options may be determined by the multivariate analysis performed on stored advertising campaigns, relating the result parameters and the advertising parameters corresponding to stored advertising campaigns, where the advertising parameters include selection of websites for displaying the internet-based advertisement. Therefore, if the multivariate analyses indicate that certain websites provide optimal performance for the stored advertising campaign, the same websites may be chosen for the first advertising campaign to optimize the first advertising campaign.

In certain exemplary embodiments, multivariate analysis on the target market for a first advertising campaign may be performed using the unique internet protocol (IP) addresses of the customers' computers to identify if the target market bears significance on the advertising campaign. Further, correlation multivariate analysis is only one type of multivariate analysis performed for each of the retrieved result parameters using the retrieved advertising parameters. In an exemplary embodiment, multiple linear regression analysis, a least square regression analysis, bivariate analysis, numerical variable transformation, cluster followed by factor analysis, principal components analysis, or a canonical correlation analysis, or a combination of each of these analysis methods may be used to determine the advertising factor for each result parameter. Further, non-linear or discontinuous functions may be used in the multivariate analysis and feedback/feed-forward methods may be applied to improve accuracy.

The advertising factors generated by block 225 are then applied to spend the received budget, where the received budget is allocated to improve the received first advertising campaign, via block 230. The received monetary budget for the received first advertising campaign, as submitted by the advertiser in block 205 is then allocated to a number of advertising parameters in accordance with the pricing option and the pricing values after determining which advertising parameter provided the highest impact for the results parameters for a matching and identified stored advertising campaign. By way of an example, if a matching advertising campaign obtained high CPM, but moderate CPC, then the multivariate analysis performed on the CPM value may indicate that for a similar first advertising campaign, the budget is optimized if a larger portion of the budget is invested in creative development, by virtue of the content for the first advertising campaign or selection of a different website for displaying the advertisement, than investing on increasing the CPC budget for the day. Block 235 concludes the method of optimizing buy-side advertising factors for internet-based advertising, according to certain exemplary embodiments.

The exemplary methods and systems described in this disclosure are illustrative, and, in alternative embodiments, certain steps can be performed in a different order, in parallel with one another, omitted entirely, and/or combined between different exemplary embodiments, and/or certain additional acts can be performed, without departing from the scope and spirit of this disclosure. Accordingly, such alternative embodiments are included in the inventions described herein.

The exemplary embodiments can be used with computer hardware and software that perform the methods and processing functions described above. As will be appreciated by those having ordinary skill in that art, the systems, methods, and procedures described herein can be embodied in a programmable computer, computer executable software, or digital circuitry. The software can be stored on computer readable media. For example, “computer-coded,” “software,” “scripts,” and “programs” are software codes used interchangeably for the purposes of simplicity in this disclosure. Further, “memory”, “computer program product”, “computer-readable medium”, and storage can include such media as, floppy disk, RAM, ROM, hard disk, removable media, flash memory, memory stick, optical media, magneto-optical media, CD-ROM, etc.

Although specific embodiments have been described above in detail, the description is merely for purposes of illustration. It should be appreciated, therefore, that many aspects described above are not intended as required or essential elements unless explicitly stated otherwise. Various modifications of and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

Although specific exemplary embodiments have been described in detail herein, the description is merely for purposes of illustration and in alternative embodiments, certain steps can be performed in a different order, in parallel with one another, omitted entirely, and/or combined between different exemplary embodiments, and/or certain additional acts can be performed, without departing from the scope and spirit of this disclosure.

### Example

In one exemplary embodiment for multivariate analysis of the stored advertising and results parameters to identify advertising factors, including pricing options and pricing values, multivariate linear regression analysis may be performed on the stored parameters. Table 1 includes exemplary values for stored advertising parameters of a stored advertising campaign that is classified as a match, by subject matter, to a first advertisement campaign. The exemplary values may be mode or median values or a single value from a single matching and identified stored advertising campaign.

TABLE 1

| Stored Advertising | | Stored Result | | |
|---|---|---|---|---|
| Parameters | | Parameters | | |
| CPC ($) | Daily | Rank | Target (clicks from | Click/1000 |
| bid (X) | Budget ($) | (Y) | select regions) | impressions |
| 1.5 | 10 | 3 | 2 | 4 |
| 1.75 | 15 | 3 | 1 | 2 |
| 2.00 | 20 | 1 | 4 | 7 |
| 1.25 | 10 | 5 | 1 | 3 |
| 1.65 | 10 | 2 | 5 | 10 |

As described above, each of the cell values in Table 1 are from the stored advertising campaign. CPC is the cost-per-click from five different days for the stored advertising campaign. Daily budget from the same five days, as well as, rank or placement of the advertisement on a search engine webpage, and the number of clicks from a target market over the five day period are also listed. The click-per-thousand-impressions may differ from the target because the click-per-thousand-impressions include all the clicks received irrespective of the target market. Of the 5 columns in Table 1, CPC and the daily budget are stored advertising parameters of the stored advertising campaign, where an advertiser for the stored advertising campaign set the CPC and daily budget values. The remainder, the rank, the target, and the click-per-thousand-impressions are stored result parameters, each obtained by tracking the stored advertising campaign when the stored advertising campaign was deployed in real time on the internet.

From the values in Table 1, multivariate regression analysis is performed for the CPC and the ranking to determine if the CPC of this existing advertising campaign contributed to the ranking of the advertisement and to find a numerical relationship between the advertising parameter and the result parameter. First, the regression equation, equation (1), for two variables is calculated as an example which can be extended to include more variables, each following the exemplary process disclosed below or any one of other application multivariate analysis, including a multiple linear regression analysis, a least square regression analysis, bivariate analysis, numerical variable transformation, cluster followed by factor analysis, principal components analysis, or a canonical correlation analysis. Equation (1) computes the correlation among parameters obtained from the stored advertising campaign. In equation (1), α and β arc least square estimates calculated from the parameters of the stored advertising campaign. Y is a dependent variable with predictive value and X is an independent variable, both based on computed values for β and α, for any value assigned to X. For purposes of the example used in this disclosure, Equation (1) is limited to two parameters, β and α.

Y=α+βX+β₁X₁+ . . . Equation (1)

For the exemplary computation in this disclosure, β is the least square estimate calculated from Equation (2) below. Using CPC as five values of “x” and the rank as the five values of “y”, each “y” for each “x”, the value of β from the equation below is −9.3 (negative).

β=Σ[(xᵢ− x̅)(yᵢ− y̅)]/(x− x̅)² Equation (2)

Further, from Equation (2), least square estimate a is calculated using Equation (3), where y̅=2.8 is the mean ranking, calculated from the rankings from Table 1 and x̅=1.63 is the mean CPC calculated from the five CPC values from Table 1. Using the value of β=−9.3 from the equation (2), α is calculated at 17.96.

α= y̅−β x̅ Equation (3)

Accordingly, Equations (1), with (2) variables Y and X becomes Equation (4), where Y or X is a predictive value depending on assigned values to X or Y respectively. Further, Equation (4) may be used to determine a theoretical expected value of X, where X is the CPC that can be expected for the same ranking Y used in Table 1.

Y=17.96−9.3X Equation (4)

X=1.93−0.11Y Equation (5)

In Table 1, the advertiser set CPC values at 1.5, 1.75, and 2.00, where the set CPC generated rankings of 3, 3, and 1 for the stored advertisement campaign. However, from Equation (4), the expected CPC for first advertising campaigns based on the same advertising parameters of the stored advertising campaign for the same ranks 3, 3, and 1 are $1.60 for ranking 3, and $1.83, for rank 1. The expected CPC for the same rankings can be calculated as shown in Equation (5), which is the rearranged form of Equation (4). The values of the expected CPC calculated from Equation (5) using hypothetical rankings of 1, 2, 3, 4, and 5 in place of Y are values of X=$1.83, $1.71, $1.60, $1.49, and $1.28. The expected CPC values from Equation (5) can be construed as CPC bids that may result in the predicted rankings of 1, 2, 3, 4, or 5 for a first advertising campaign that is similar or same to the stored advertising campaign, considering all other advertising parameters set by the stored advertising campaign is carried over to the first advertising campaign.

TABLE 2

| | Real Rank | |
|---|---|---|
| | from | |
| | Existing | |
| CPC | Advertising | Expected CPC ($) |
| ($) | campaign | X = 1.93 − 0.11 Y |
| 1.5 | 3 | 1.60 (Y = hypothetical ranking 3) |
| 1.75 | 3 | 1.60 (Y = hypothetical ranking 3) |
| 2.00 | 1 | 1.83 (Y = hypothetical ranking 1) |
| 1.25 | 5 | 1.28 (Y = hypothetical ranking 5) |
| 1.65 | 2 | 1.71 (Y = hypothetical ranking 2) |

From Equation (5), relationship information relating CPC and rankings may be calculated for this existing advertisement campaign. Here, the relationship information is calculated as a percentage of the Coefficient of Determination using Equations (6), (7), and (8) listed below, where Equation (6) is the Coefficient of Determination.

R²=1−(Sₑᵣᵣ/Sₜₒₜ) Equation (6)

sₑᵣᵣ=Σ(xᵢ−fᵢ)² Equation (7)

Sₜₒₜ=Σ(xᵢ= x̅) Equation (8)

Sₑᵣᵣ is the residual sum of squares and can be obtained from the values “y,” where “y” are the values of CPC in Table 1, and “f” are values of expected CPC calculated from Equation (5). Using only expected values of CPC (“f”) calculated from the hypothetical rankings shown in Table 2 and the real values of CPC (“x”) according to the rankings of Table (1), we get the expected CPCs (“f”) values which is used in Equation (7) to derive the value of Sₑᵣᵣ as 0.0659. Using the value of x̅=1.63 from Table (1), Sₜₒₜ is calculated to be 0.313. Therefore, the value of R² from Equation (6) is calculated to be 0.978, which is the Coefficient of Determination, and where the Coefficient of Determination translates to a relationship value of 97.8% for the relationship between the CPC and ranking for the stored advertising campaign. The relationship parameter thus obtained is an example of the pricing options of the advertising factors that may be used to allocate a campaign budget. The range of expected CPC for a proposed ranking of 1 to 2 for a first advertising campaign can be drawn from the expected ranking as being between a range of $1.71 (rank 2) to $1.83 (rank 1). Further, the proposed daily budget may be calculated from the clicks-per-thousand-impressions in Table 1, using the expected CPC values, where the proposed budget range may be calculated as being between 1.71*10 and 1.83*7 or between $12.81 and $17.1 per day. Alternatively, the budget can be a deviation from the maximum value of $12.81 or $17.1 per day. The proposed budget range when calculated under an alternative pricing model (such as CPM) would be displayed as range across a selected level of probability, where the range may indicate a standard deviation from the calculated values.

Accordingly, since there is a correlation existing between the “CPC” advertising parameter and the “ranking” result parameter, it may be construed that for a first advertising campaign with matching subject matter to the existing advertising campaign should invest a significant part of the budget to maintain a budget per day. However, this is purely an example for an analysis of two stored advertising parameters against a number of stored result parameters. By extending the multivariate analysis to include the influence of stored advertising parameters on each of the stored result parameters, relationships between each of the stored advertising and result parameters for a stored advertising campaign can be generated. Further, the advertising parameters can also be measured in terms of the total budget contribution, where each advertising parameter corresponding to a first advertising campaign is assigned a percentage value of the existing advertising budget, based on the correlation established between the stored results parameter and the stored advertisement parameters.

Further, an internet advertising equation, Equation (9), may be used to improve the pricing options and the pricing values provided from the advertising factors.

CPM*CTR*α*β=COST/CUSTOMER Equation (9)

Equation (9) may form part of the computation step 225 in FIG. 2 and may be implemented via computing sub-module 120 of FIG. 1. Accordingly, any values of actual CPC obtained as a pricing value from identified stored advertising campaigns may be fed as input to Equation (9). A CPM may be calculated based on the existing advertising budget established by the advertiser for the first advertising campaign. The CTR may be obtained as a pricing option from the same stored advertising campaign. Further, the CTR and CPM may be mode or median values from the identified stored advertising campaigns. “α” is a market risk factor or variability that indicates that the value to obtain a single customer (cost/customer calculated from Equation (9)) may depend on such variables as the population of the target segment, geographical targeting, etc. In an exemplary embodiment, “α” may be associated with advertising campaigns displayed to certain subsets of an internet population, as a test subset, at different times. Accordingly, the test subset information may include information that varies from the real population, but may be used to calculate the approximate values for “α.” Further, “β” is a campaign risk factor that indicates that the accuracy of the suggested budget utilization for the first advertising campaign in obtaining a customer may vary by such variables as creative, offer, pricing, etc., where each of these variables may be controllable. Also, “β” represents identified advertising and result parameters, determined via the multivariate analysis of each factor independently, where some of the factors may or may not be correlated. Finally, the sum of the market risk and campaign risk is 1, Equation (10).

α+β=1 Equation (10)

Accordingly, any variation in actual values of an exemplary result parameter, such as the actual CPC and ranking, and subsequently calculated CTR and CPM, may be compared with predicted values, as shown in Table 2. The variation indicates the values of the risk factors, which may be calculated after tracking results for the first advertising campaign or identified stored advertising campaigns, within certain time periods.

What is claimed is:

1. A computer-implemented method for computing buy-side advertising factors, the advertising factors including pricing options and pricing values for internet-based advertising, the method comprising:
receiving, on a computer, data related to a first advertising campaign and an existing budget for the first advertising campaign, wherein the first advertising campaign is an internet-based advertising campaign;
classifying, on the computer, the data corresponding to the first advertising campaign, the data comprising advertising subject matter, at least one of a plurality of advertising parameters, and at least one of a plurality of result parameters;
identifying, on the computer, one or more stored advertising campaigns with similar classification as the classified data in the classification step;
retrieving, on the computer, for each of the identified stored advertising campaigns, a plurality of corresponding advertising parameters and a plurality of corresponding result parameters;
computing, on the computer, buy-side advertising factors from at least one of the retrieved advertising parameters and at least one of the retrieved result parameters, the computed buy-side advertising factors comprising suggested pricing options and pricing values for the existing budget associated with the received first advertising campaign; and
spending the existing budget on improving the first advertising campaign in accordance with the computed buy-side advertising factors.

2. The method according to claim 1, wherein the step of classifying the data related to the first advertising campaign further comprises:
associating, on the computer, to the first advertising campaign, one or more classification categories, thereby classifying the advertising subject matter of the first advertising campaign;
sorting, on the computer, for the first advertising campaign, the corresponding advertising parameters and the corresponding result parameters in accordance to the values stored within each of the corresponding advertising parameters and the corresponding result parameters; and
providing, on the computer, to the identifying step, the classification categories of the first advertising campaign, and a maximum value and a minimum value identified by the storing step for each of the advertising parameters and the result parameters corresponding to the first advertising campaign.

3. The method according to claim 1, wherein the identifying step further comprises:
matching, on the computer, one or more classification categories of the first advertising campaign with one or more classification categories associated with the one or more stored advertising campaigns, thereby identifying one or more stored advertising campaigns with one or more matched classification categories;
verifying, by the computer, if at least one value stored within at least one result parameter corresponding to the matched one or more stored advertising campaigns is optimal compared to a minimum value of a same result parameter corresponding to the first advertising campaign; and
providing, by the computer, to the retrieving step, the at least one result parameter and the optimal value stored within it, along with advertising parameters corresponding to the stored advertising campaign in the verifying step.

4. The method according to claim 2, wherein the step of associating classification categories include adding a software tag to the advertising campaign, the software tag comprising one or more advertising targets for the advertising campaign.

5. The method according to claim 4, wherein the advertising targets include product, service, brand name, quality, person, and product function.

6. The method according to claim 1, wherein the result parameter comprises values generated when the advertising campaign is deployed as an active campaign on the internet.

7. The method according to claim 1, wherein the advertising parameters includes bid cost-per-click and budget-per-day.

8. The method according to claim 1, wherein the result parameters include an average ranking, an actual cost-per-click (CPC), a creative measure, conversion rate, and a measure for a market targeted by the advertisement campaign.

9. The method according to claim 8, wherein the creative measure includes one or a combination of a value for clicks-per-thousand-impressions of the advertising campaign or the number of keywords corresponding to the advertising campaign.

10. The method according to claim 1, wherein the computing step uses multivariate analysis on the retrieved advertising parameters and retrieved result parameters to identify from the retrieved result parameters at least one retrieved result parameter that is most affected by the retrieved advertising parameters.

11. The method according to claim 1, wherein the computing step involves a multivariate analysis to identify one of a correlation between the retrieved result parameters and each of the retrieved advertising parameter, a group difference in a group comprising the retrieved advertising parameter values for each retrieved result parameter value, and a dependent and independent relationships between each retrieved result parameter and the plurality of retrieved advertising parameters.

12. The method according to claim 11, wherein the multivariate analysis used in computing the advertising factors includes one or a combination of multiple linear regression analysis, a least square regression analysis, bivariate analysis, numerical variable transformation, cluster followed by factor analysis, principal components analysis, and a canonical correlation analysis.

13. The method according to claim 1, wherein the subject matter of the advertising campaign includes the creative content and any keywords for which the advertising campaign is displayed to an end-user, and wherein the creative content further includes color, shape, positioning, brand names, product description, font style and size, images, flash content, and interactive features in the advertising campaign.

14. The method according to claim 1, wherein the pricing options includes the option to spend the existing budget on one or a combination of improving creative content, improving bid cost-per-click or improving daily budget for the advertising campaign.

15. A computer-implemented system for computing buy-side advertising factors, the advertising factors including pricing options and pricing values for internet-based advertising, the system comprising:
a computer for receiving data related to a first advertising campaign and an existing budget for the first advertising campaign, wherein the first advertising campaign is an internet-based advertising campaign;
wherein the computer is configured to classify the data corresponding to the first advertising campaign, the data comprising advertising subject matter, at least one of a plurality of advertising parameters, and at least one of a plurality of result parameters;
wherein the computer is configured to identify one or more stored advertising campaigns with at least one classification that is the same as the classifications obtained while classifying the data corresponding to the first advertising campaign;
wherein the computer is configured to retrieve, for each of the identified stored advertising campaigns, a plurality of corresponding advertising parameters and a plurality of corresponding result parameters; and
wherein the computer is configured to compute advertising factors from at least one of the retrieved advertising parameters and at least one of the retrieved result parameters, the advertising factors comprising suggested pricing options and pricing values for the existing budget associated with the received first advertising campaign.

16. The system according to claim 15, wherein the computer configured to classify data related to the first advertising campaign
sorts, for the first advertising campaign, the corresponding advertising parameters and the corresponding result parameters according to the values stored within each of the corresponding advertising parameters and the corresponding result parameters;
identifies one or more stored advertising campaigns with at least one classification that is the same as the classified data; and
provides the classification categories of the first advertising campaign, a maximum value, and a minimum value identified by sorting the first advertising campaign.

17. The system according to claim 15, wherein the computer configured to classify one or more stored advertising campaigns
matches one or more classification categories of the first advertising campaign with one or more classification categories associated with the one or more stored advertising campaigns, thereby identifying one or more stored advertising campaigns with one or more matched classification categories;
verifies if at least one value stored within at least one result parameter corresponding to the matched one or more stored advertising campaigns is optimal compared to a maximum value and a minimum value of a same result parameter corresponding to the first advertising campaign; and
provides to the computer configured to retrieve a plurality of corresponding advertising parameters and a plurality of corresponding result parameters, the at least one result parameter and the optimal value stored within it, along with advertising parameters corresponding to the stored advertising campaign verified from matching one or more stored advertising campaigns.

18. The system according to claim 16, wherein one or more classification categories associated with the one or more stored advertising campaigns comprises a software tag associated to the one or more stored advertising campaign, the software tag comprising one or more advertising targets for the advertising campaign.

19. The system according to claim 18, wherein the advertising targets include product, service, brand name, quality, person, and product function.

20. The system according to claim 15, wherein the result parameter comprises values generated when the advertising campaign is deployed as an active campaign on the internet.

21. The system according to claim 15, wherein the advertising parameters includes bid cost-per-click and budget-per-day.

22. The system according to claim 15, wherein the result parameters include an average ranking, an actual cost-per-click (CPC), a creative measure, conversion rate, and a measure for a market targeted by the advertisement campaign.

23. The system according to claim 22, wherein the creative measure includes one or a combination of a value for clicks-per-thousand-impressions of the advertising campaign or the number of keywords corresponding to the advertising campaign.

24. The system according to claim 15, wherein the computer configured to compute uses multivariate analysis on the retrieved advertising parameters and retrieved result parameters to identify from the retrieved result parameters at least one retrieved result parameter that is most affected by the retrieved advertising parameters.

25. The system according to claim 15, wherein the computer configured to compute performs a multivariate analysis to identify one of a correlation between the retrieved result parameters and each of the retrieved advertising parameter, a group difference in a group comprising the retrieved advertising parameter values for each retrieved result parameter value, and a dependent and independent relationships between each retrieved result parameter and the plurality of retrieved advertising parameters.

26. The system according to claim 25, wherein the multivariate analysis used in computing the advertising factor includes one or a combination of multiple linear regression analysis, a least square regression analysis, bivariatc analysis, numerical variable transformation, cluster followed by factor analysis, principal components analysis, and a canonical correlation analysis.

27. The system according to claim 15, wherein the subject matter of the advertising campaign includes the creative content and any keywords for which the advertising campaign is displayed to an end-user, and wherein the creative content further includes color, shape, positioning, brand names, product description, font style and size, images, flash content, and interactive features in the advertising campaign.

28. The system according to claim 15, wherein the pricing options includes the option to spend the existing budget on one or a combination of improving creative content, improving bid cost-per-click or improving daily budget for the advertising campaign.

29. A computer program product comprising:
a computer-readable medium having computer-readable program code embodied therein for computing buy-side advertising factors, the advertising factors including pricing options and pricing values for internet-based advertising, the computer program product comprising:
the computer-readable medium for receiving data related to a first advertising campaign and an existing budget for the first advertising campaign, wherein the first advertising campaign is an internet-based advertising campaign;
computer-readable medium for classifying the data corresponding to the first advertising campaign, the data comprising advertising subject matter, at least one of a plurality of advertising parameters, and at least one of a plurality of result parameters;
the computer-readable medium for identifying one or more stored advertising campaigns with at least one classification that is the same as the classified data corresponding to the first advertising campaign;
the computer-readable medium for retrieving, for each of the identified stored advertising campaigns, a plurality of corresponding advertising parameters and a plurality of corresponding result parameters;
the computer-readable medium for computing advertising factors from at least one of the retrieved advertising parameters and at least one of the retrieved result parameters, the advertising factors comprising suggested pricing options and pricing values for the existing budget associated with the received first advertising campaign; and
spending the existing budget on improving the first advertising campaign in accordance with the computed advertising factors.

30. The computer program product according to claim 29, wherein the computer-readable medium for classifying the data related to the first advertising campaign further comprises:
the computer-readable medium for associating, to the first advertising campaign, one or more classification categories, thereby classifying the advertising subject matter of the first advertising campaign;
the computer-readable medium for sorting, for the first advertising campaign, the corresponding advertising parameters and the corresponding result parameters in accordance to the values stored within each of the corresponding advertising parameters and the corresponding result parameters; and
the computer-readable medium for providing, to the computer-readable medium for identifying one or more stored advertising campaigns, the classification categories of the first advertising campaign, and a maximum value and a minimum value identified by storing for each of the advertising parameters and the result parameters corresponding to the first advertising campaign.

31. The computer program product according to claim 29, wherein the computer-readable medium for identifying one or more stored advertising campaigns further comprises:
the computer-readable medium for matching, one or more classification categories of the first advertising campaign with one or more classification categories associated with the one or more stored advertising campaigns, thereby identifying one or more stored advertising campaigns with one or more matched classification categories;
the computer-readable medium for verifying if at least one value stored within at least one result parameter corresponding to the matched one or more stored advertising campaigns is optimal compared to a maximum value and a minimum value of a same result parameter corresponding to the first advertising campaign; and
the computer-readable medium for providing, to the computer-readable medium for retrieving a plurality of corresponding advertising parameters and a plurality of corresponding result parameters, the at least one result parameter and the optimal value stored within it, along with advertising parameters corresponding to the stored advertising campaign from the computer-readable medium for verifying.

32. The computer program product according to claim 30, wherein the computer-readable medium for associating classification categories include adding a software tag to the advertising campaign, the software tag comprising one or more advertising targets for the advertising campaign.

33. The computer program product according to claim 32, wherein the advertising targets include product, service, brand name, quality, person, and product function.

34. The computer program product according to claim 29, wherein the result parameter comprises values generated when the advertising campaign is deployed as an active campaign on the internet.

35. The computer program product according to claim 29, wherein the advertising parameters includes bid cost-per-click and budget-per-day.

36. The computer program product according to claim 29, wherein the result parameters include an average ranking, an actual cost-per-click (CPC), a creative measure, conversion rate, and a measure for a market targeted by the advertisement campaign.

37. The computer program product according to claim 36, wherein the creative measure includes one or a combination of a value for clicks-per-thousand-impressions of the advertising campaign or the number of keywords corresponding to the advertising campaign.

38. The computer program product according to claim 29, wherein the computer-readable medium for computing uses multivariate analysis on the retrieved advertising parameters and retrieved result parameters to identify from the retrieved result parameters at least one retrieved result parameter that is most affected by the retrieved advertising parameters.

39. The computer program product according to claim 29, wherein the computer-readable medium for computing involves a multivariate analysis to identify one of a correlation between the retrieved result parameters and each of the retrieved advertising parameter, a group difference in a group comprising the retrieved advertising parameter values for each retrieved result parameter value, and a dependent and independent relationships between each retrieved result parameter and the plurality of retrieved advertising parameters.

40. The computer program product according to claim 39, wherein the multivariate analysis used in computing the advertising factor includes one or a combination of multiple linear regression analysis, a least square regression analysis, bivariate analysis, numerical variable transformation, cluster followed by factor analysis, principal components analysis, and a canonical correlation analysis.

41. The computer program product according to claim 29, wherein the subject matter of the advertising campaign includes the creative content and any keywords for which the advertising campaign is displayed to an end-user, and wherein the creative content further includes color, shape, positioning, brand names, product description, font style and size, images, flash content, and interactive features in the advertising campaign.

42. The computer program product according to claim 29, wherein the pricing options includes the option to spend the existing budget on one or a combination of improving creative content, improving bid cost-per-click or improving daily budget for the advertising campaign.
